(19) United States
(12) Patent Application Publication
(10) Pub. No.: US 2015/0315492 A1
(43) Pub. Date: Nov. 5, 2015

(54) SYSTEMS AND METHODS FOR IMPROVING LIQUID PRODUCT YIELD OR QUALITY FROM DISTILLATION UNITS

(71) Applicants: Patrick Loring Hanks, Bridgewater, NJ (US); Michel DAAGE, Hellertown, PA (US); Thomas Francis DEGNAN, JR., Philadelphia, PA (US); Kenneth R. GRAZIANI, Fairfax, VA (US)

(72) Inventors: Patrick Loring Hanks, Bridgewater, NJ (US); Michel DAAGE, Hellertown, PA (US); Thomas Francis DEGNAN, JR., Philadelphia, PA (US); Kenneth R. GRAZIANI, Fairfax, VA (US)

(73) Assignee: ExxonMobil Research and Engineering Company, Annandale, NJ (US)

(21) Appl. No.: 14/691,998

(22) Filed: Apr. 21, 2015

Related U.S. Application Data
(60) Provisional application No. 61/986,917, filed on May 1, 2014.

(51) Int. Cl. C10G 55/02; B01J 19/00; C01B 3/02; C10G 55/04; C10G 55/06; B01J 19/24; C10G 69/02

(52) U.S. Cl. CPC C10G 55/02; B01J 19/24; B01J 19/008; C10G 69/02; C10G 55/04; C10G 55/06; C01B 3/02; B01J 2219/24

(57) ABSTRACT

Methods and systems are provided for improving liquid product quality or yield from atmospheric or vacuum distillation unit by subjecting fractionated streams from such distillation units to hydrodynamic cavitation.

### CROSS-REFERENCE TO RELATED APPLICATION

This application claims priority to U.S. Patent Application Ser. No. 61/986,917, filed May 1, 2014.

### FIELD

The present invention relates to systems and methods of improving liquid product yields or quality from atmospheric and vacuum distillation units. More specifically, the present invention relates to a system and method of increasing liquid product yield by integration of a hydrodynamic cavitation unit with an atmospheric or vacuum distillation unit.

### BACKGROUND

There is a general need for oil refining processes that enable refineries to efficiently increase yields of more valuable hydrocarbon liquid products. Currently, refineries principally rely on fluid catalytic cracking (“FCC”), hydrocracking, or coking to convert less valuable, higher molecular weight oils to lighter, more valuable hydrocarbon products. Although these conversion systems are effective and widely used, they typically require significant capital investment and/or operating costs to increase throughput or conversion.

New processes that increase the yield or quality of lighter hydrocarbon products and/or optionally reduce the demand on these FCC and hydrocracking systems are therefore desired.

### SUMMARY

The present invention addresses these and other problems by providing methods and systems for improving liquid product quality or yield from atmospheric or vacuum distillation units by subjecting fractionated streams from such distillation units to hydrodynamic cavitation.

In one aspect, a method is provided for Improving product from a vacuum or atmospheric distillation unit. The method includes feeding a fractionated stream from an atmospheric or vacuum distillation unit to a hydrodynamic cavitation unit wherein the fractionated stream is subjected to hydrodynamic cavitation to convert a portion of hydrocarbons in the fractionated stream to lower molecular weight hydrocarbons in a cavitated stream. The fractionated stream is selected from a group consisting of an atmospheric tower bottoms stream, an atmospheric gas oil stream, a vacuum gas oil stream, a quench oil stream, a vacuum tower bottoms stream, and combinations thereof.

In another aspect, a system is provided for improving products from a distillation unit. The system includes an atmospheric or vacuum distillation unit; and a hydrodynamic cavitation unit receiving a fractionated stream from the distillation unit and subjecting the fractionated stream to hydrodynamic cavitation to convert a portion of hydrocarbons in the fractionated stream to lower molecular weight hydrocarbons in a cavitated stream. The fractionated stream is selected from a group consisting of an atmospheric tower bottoms stream, an atmospheric gas oil stream, a vacuum gas oil stream, a quench oil stream, a vacuum tower bottoms stream, and combinations thereof.

### BRIEF DESCRIPTION OF THE DRAWINGS

FIG. 1 is a cross section view of an exemplary hydrodynamic cavitation unit, which may be employed in one or more embodiments of the present invention.

FIG. 2 is a flow diagram of a system for improving the liquid product yield from pipestills, according to one or more embodiments of the present invention.

### DETAILED DESCRIPTION

Described herein are systems and methods for improving liquid product yield. from atmospheric and vacuum distillation units. In any embodiment, the methods and systems may improve the liquid product yield by subjecting the atmospheric tower bottoms or atmospheric gas oil fraction to hydrodynamic cavitation to convert at least a portion of the hydrocarbon molecules to lower molecular weight hydrocarbons. The lower molecular weight hydrocarbons may be fed back to the atmospheric distillation unit for fractionation.

Feeds suitable for cavitation includes atmospheric tower bottoms, atmospheric gas oils, vacuum tower bottoms, vacuum gas oils, quench oil streams and combinations thereof. Preferably the feed stream has a 15 boiling point (the temperature at which 5 wt % of the material boils off at atmospheric pressure) of 380° F. or more, or more preferably a T5 of 500° F. or more.

As used herein the term “atmospheric distillation unit” refers to a fractionation unit in which hot crude oil is fed and separated into various product streams (such as naphtha, kerosene, diesel and atmospheric gas oils) at about atmospheric pressure. The atmospheric distillation unit may be used to fractionate fuel products, lubricant products, or combinations thereof.

The term “atmospheric tower bottoms” refers to the residue or the fraction of crude oil that boils off at a temperature greater than that of which the crude oil is exposed to in the atmospheric distillation unit. Typically, this fraction has a T5 boiling point of at least 500° F., or in some cases at least 680° F. This fraction often has a T95 (the temperature at which most of the material boils off, leaving 5 wt % of the material of about 1500° F. or greater.

The term “atmospheric gas oil” refers to the any atmospheric distillation side stream heavier than naphtha and includes products known as light atmospheric gas oil, heavy atmospheric gas oil or combinations thereof. This fraction typically has a T5 of about 380° F. or greater. This fraction generally has a T95 of about 730° F. or less.

The term “vacuum as oils” refers to any side stream from the vacuum distillation of atmospheric tower bottoms and/or atmospheric gas oils. These fractions may have a T5 of about 500° F. or greater, or 680° F. or greater, and a T95 of 1100° F. or less.

The term “vacuum tower bottoms” refers to a residue or a fraction of crude oil that doesn't boil off at the temperature and pressure at which the vacuum distillation unit operates. These fractions typically have a T5 of about 800° F. or more, and a T95 of 1500° or more.

The term “quench oil stream” refers to hydrocarbon streams such as atmospheric tower bottoms or vacuum tower bottoms that have been cooled and recycled to one of the distillation units to prevent hydrocarbon cracking.

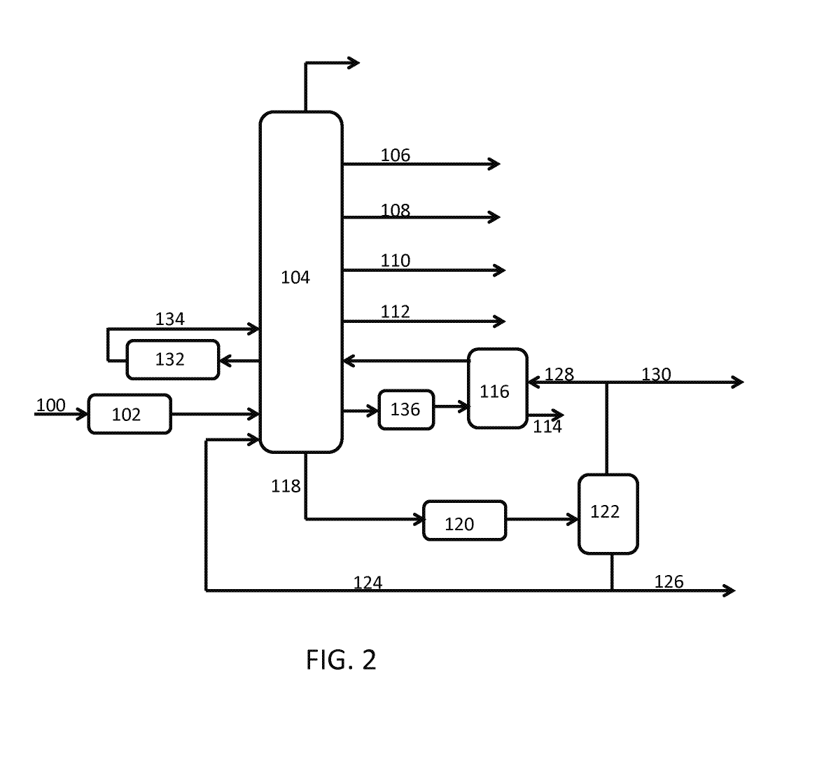

In an exemplary embodiment, as illustrated in FIG. 2, a crude oil stream 100 is fed to a desalter 102 and then to an atmospheric distillation unit 104 where the crude oil is separated into fractions for further treatment or product blending. Although not shown in FIG. 2, the crude oil stream 102 may be heated, e.g., to around 400° C., by a furnace and/or by heat exchangers integrated with one or more pump-around circuits from the atmospheric distillation unit 104 before the crude oil stream 102 is fed to the atmospheric distillation unit 104.

In atmospheric distillation unit 104, various fractions of the crude oil stream 102 are separated by distillation. For example, naphtha stream 106, kerosene stream 108, diesel stream 110, light atmospheric gas oil stream 112, and heavy atmospheric gas oil stream 114 may be separated by the different boiling points of the respective fractions. As illustrated in FIG. 2, the heavy gas oil stream is further side stripped in stripper 116 with the aid of steam. Although not shown, each of the product streams 106, 108, 110, 112 may also be side stripped as well.

An atmospheric tower bottoms stream 118, comprising the residue or distillate of the atmospheric distillation unit 104, is fed to a hydrodynamic cavitation unit 120, where the atmospheric tower bottoms stream 118 is subjected to hydrodynamic cavitation to convert at least a portion of the hydrocarbons in the atmospheric tower bottoms stream 118 to lower molecular weight hydrocarbons. The hydrodynamic cavitation unit 120 and hydrodynamic cavitation process is described in greater detail subsequently. Although not shown, a pump may be employed upstream of the hydrodynamic cavitation unit 120 to pump the atmospheric tower bottoms stream 118 to 400-2000 psig or greater at process temperatures.

The cavitated stream is then fed to separation unit 122 where a lighter fraction is further fractionated into product streams. In any embodiment, the lighter fraction from the separation unit 122 may be fed to the side stripper 116, with the lighter components being fed directly to the atmospheric distillation unit 104. If the side stripper for the atmospheric gas oil is hydraulically-constrained, then the lighter fraction (the vapor fraction) from the separation unit 122 may be fed via stream 130 to another unit with spare fractionation capacity, such as a hydrotreater, a fluid catalytic converter, or a coker. Alternatively, the lights can be condensed and fed to a distillate hydroprocessing reactor where any naphtha range molecules can be removed after hydrotreating. “Naphtha” refers to a hydrocarbon material having a T5 of 80° F. or greater and a T95 up to 380° F., “Distillate” refers to petroleum fractions heavier than gasoline and naphtha, which may be used for diesel and other fuel oils.

The heavier fraction (the liquid fraction) from the separation unit 122 may then be fed to a vacuum distillation unit for further fractionation via vacuum distillation unit feed stream 126. Optionally, a portion of the heavier fraction from the separation unit 122 may be recycled to the bottom of atmospheric distillation unit 104 via a recycle stream 124.

Hydrodynamic cavitation units may be utilized in other locations integral to the atmospheric distillation unit 104 to improve liquid product yields or to further convert larger hydrocarbons to lighter, more valuable hydrocarbons. For example, a hydrodynamic cavitation unit may be employed in one or more side stripper circuits to subject such stream to hydrodynamic cavitation. As illustrated in FIG. 2, a hydrodynamic cavitation unit 136 may be employed in the heavy atmospheric gas oil side stripper circuit upstream of the side stripper 116. In any embodiment, a separator may be employed between the hydrodynamic cavitation unit 136 and side stripper 116 to allow for vapor product to be fed back to the atmospheric distillation unit 104 or to the side stripper of the light atmospheric gas oil stream 112, thereby reducing the amount of cavitatedly-converted hydrocarbons hydrocarbons that are fed to the side stripper 116. Such installations may be particularly useful for fuel distillation units that process waxy crudes or where there is a need to modify cold flow properties of fuel oils.

Hydrodynamic cavitation units may also be employed in one or more pump-around heat-exchanger circuits that are used for heat management of the atmospheric distillation unit 104 (e.g., for preheating the crude oil stream 100). As illustrated in FIG. 2, a portion of an atmospheric gas oil fraction is fed by high pressure pump (not shown) to a hydrodynamic cavitation unit 132 where the atmospheric gas oil fraction is subjected to hydrodynamic cavitation. The cavitated stream is then injected into the atmospheric distillation unit 104 after heating the crude oil stream 100. Optionally, a vapor-liquid separation unit may be employed downstream of the hydrodynamic cavitation unit 132 to allow at least a portion of the cavitatedly-converted hydrocarbons in the vapor phase to be injected into the atmospheric distillation unit 104 at a different location than the liquid phase.

Similarly, a hydrodynamic cavitation unit may be employed in one or more of the pump-around heat exchanger circuits on a vacuum distillation unit receiving as its feed the atmospheric tower bottoms stream 118 or vacuum distillation unit feed stream 126. In such a case, the cavitated stream could be separated with a vapor-liquid separator and the vapor phase can be routed back to the atmosphere distillation unit 104, such as via a side stripper.

### Hydrodynamic Cavitation Unit

The term “hydrodynamic cavitation”, as used herein refers to a process whereby fluid undergoes convective acceleration, followed by pressure drop and bubble formation, and then convective deceleration and bubble implosion. The implosion occurs faster than most of the mass in the vapor bubble can transfer to the surrounding liquid, resulting in a near adiabatic collapse. This generates extremely high localized energy densities (temperature, pressure) capable of dealkylation of side chains from large hydrocarbon molecules, creating free radicals and other sonochemical reactions.

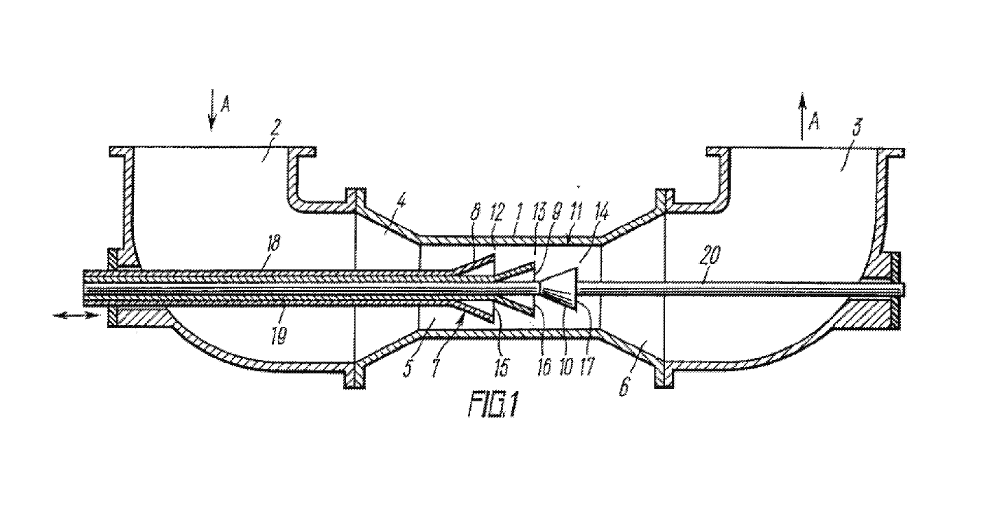

The term “hydrodynamic cavitation unit” refers to one or more processing units that receive a fluid and subject the fluid to hydrodynamic cavitation. In any embodiment, the hydrodynamic cavitation unit may receive a continuous flow of the fluid and subject the flow to continuous cavitation within a cavitation region of the unit. An exemplary hydrodynamic cavitation unit is illustrated in FIG. 1. Referring to FIG. 1, there is a diagrammatically shown view of a device consisting of a housing I having inlet opening 2 and outlet opening 3, and internally accommodating a contractor 4, a flow channel 5 and a diffuser 6 which are arranged in succession on the side of the opening 2 and are connected with one another. A cavitation region defined at least in part by channel 5 accommodates a baffle body 7 comprising three elements in the form of hollow truncated cones 8, 9, 10 arranged in succession in the direction of the flow and their smaller bases are oriented toward the contractor 4. The baffle body 7 and a wall 11 of the flow channel 5 form sections 12, 13, 14 of the local contraction of the flow arranged in succession in the direction of the flow and shaving the cross-section of an annular profile. The cone 8, being the first in the direction of the flow, has the diameter of a larger base 15 which exceeds the diameter of a larger base 16 of the subsequent cone 9. The diameter of the larger base 16 of the cone 9 exceeds the diameter of a larger base 17 of the subsequent cone 10. The taper angle of the cones 8, 9, 10 decreases from each preceding cone to each subsequent cone.

The cones may be made specifically with equal taper angles in an alternative embodiment of the device. The cones 8, 9, 10 are secured respectively on rods 18, 19, 20 coaxially installed in the flow channel 5. The rods 18, 19 are made hollow and are arranged coaxially with each other, and the rod 20 is accommodated in the space of the rod 19 along the axis. The rods 19 and 20 are connected with individual mechanisms (not shown in FIG. 1) for axial movement relative to each other and to the rod 18. In an alternative embodiment of the device, the rod 18 may also be provided with a mechanism for movement along the axis of the flow channel 5. Axial movement of the cones 8, 9, 10 makes it possible to change the geometry of the baffle body 7 and hence to change the profile of the cross-section of the sections 12, 13, 14 and the distance between them throughout the length of the flow channel 5 which in turn makes it possible to regulate the degree of cavitation of the hydrodynamic cavitation fields downstream of each of the cones 8, 9, 10 and the multiplicity of treating the components. For adjusting the cavitation fields, the subsequent cones 9, 10 may be advantageously partly arranged in the space of the preceding cones 8, 9; however, the minimum distance between their smaller bases should be at least equal to 0.3 of the larger diameter of the preceding cones 8, 9, respectively. If required, one of the subsequent cones 9, 10 may be completely arranged in the space of the preceding cone on condition of maintaining two working elements in the baffle body 7. The flow of the fluid under treatment is show by the direction of arrow A.

Hydrodynamic cavitation units of other designs are known and may be employed in the context of the inventive systems and processes disclosed herein. For example, hydrodynamic cavitation units having other geometric profiles are illustrated and described in U.S. Pat. No. 5,492,654, which is incorporated by reference herein in its entirety. Other designs of hydrodynamic cavitation units are described in the published literature, including but not limited to U.S. Pat. Nos. 5,937, 906; 5,969,207; 6,502,979; 7,086,777; and 7,357,566, all of which are incorporated by reference herein in their entirety.

In an exemplary embodiment, conversion of hydrocarbon fluid is achieved by establishing a hydrodynamic flow of the hydrodynamic fluid through a flow-through passage having a portion that ensures the local constriction for the hydrodynamic flow, and by establishing a hydrodynamic cavitation field (e.g., within a cavitation region of the cavitation unit) of collapsing vapor bubbles in the hydrodynamic field that facilitates the conversion of at least a part of the hydrocarbon components of the hydrocarbon fluid.

For example, a hydrocarbon fluid may be fed to a flow-through passage at a first velocity, and may be accelerated through a continuous flow-through passage (such as due to constriction or taper of the passage) to a second velocity that may be 3 to 50 times faster than the first velocity. As a result, in this location the static pressure in the flow decreases, for example from 1-20 kPa. This induces the origin of cavitation in the flow to have the appearance of vapor-filled cavities and hubbies. In the flow-through passage, the pressure of the vapor hydrocarbons inside the cavitation bubbles is 1-20 kPa. When the cavitation bubbles are carried away in the flow beyond the boundary of the narrowed flow-through passage, the pressure in the fluid increases.

This increase in the static pressure drives the near instantaneous adiabatic collapsing of the cavitation bubbles. For example, the bubble collapse time duration may be on the magnitude of 10⁻⁶ to 10⁻⁸ second. The precise duration of the collapse is dependent upon the size of the bubbles and the static pressure of the flow. The flow velocities reached during the collapse of the vacuum may be 100-1000 times faster than the first velocity or 6-100 times faster than the second velocity. In this final stage of bubble collapse, the elevated temperatures in the bubbles are realized with a velocity of 10¹⁰-10¹² K/sec. The vaporous/gaseous mixture of hydrocarbons found inside the bubbles may reach temperatures in the range of 1500-15,000K at a pressure of 100-1500 MPa. Under these physical conditions inside of the cavitation bubbles, covalent bond breakage of hydrocarbon molecules occurs, such that the pressure and the temperature in the bubbles surpasses the magnitude of the analogous parameters of other cracking processes. In addition to the high temperatures formed in the vapor bubble, a thin liquid film surrounding the bubbles is subjected to high temperatures where additional chemistry (i.e., thermal cracking of hydrocarbons and dealkylation of side chains) occurs. The rapid velocities achieved during the implosion generate a shockwave that can: mechanically disrupt agglomerates (such as asphaltene agglomerates or agglomerated particulates), create emulsions with small mean droplet diameters, and reduce mean particulate size in a slurry.

In accordance with the systems and methods disclosed herein, suitable feeds for hydrodynamic cavitation include those with a T95 (the temperature at which most all the material has boiled off, leaving only 5% remaining in the distillation pot) of at least 600° F. (316° C.), such as between 600° F. (316° C.) and 1300° F. (704° C.), or more preferably at least 800° F.

For streams comprising a fraction of hydrocarbons boiling at a temperature greater than or equal 1050° F., 1 to 35 wt % of such hydrocarbons boiling at a temperature greater than or equal to 1050° F. may be cracked and converted to lower molecular weight hydrocarbons. In any embodiment, at least 2 wt %, or at least 3 wt %, or at least 5 wt %, or at least 10 wt %, or at least 15 wt %, or at least 20 wt % of such hydrocarbons may be converted. Similarly, conversion may he controlled to limit the amount of conversion of such hydrocarbons to 30 wt % or less, 25 wt % or less, 20 wt % or less, 15 wt % or less, 10 wt % or less, or 5 wt % or less. Furthermore, any range defined by any pair of the foregoing end points is specifically envisioned. The degree of conversion may he controlled by the degree of cavitation to which the stream is subjected, including, for example, the number of cavitation stages to which the stream is subjected or the energy which is transmitted into the stream in each cavitation stage. Thus, it should be appreciated that the hydrodynamic cavitation unit may comprise one or more cavitation devices, each device having one or more cavitation stages, wherein the devices (when more than one is employed) may be arranged in series or parallel.

### Specific Embodiments

In order to better illustrate aspects of the present invention, the following specific embodiments are provided:

Paragraph A—A method for Improving products from a distillation unit comprising: feeding a fractionated stream from an atmospheric or vacuum distillation unit from the distillation unit to a hydrodynamic cavitation unit wherein the fractionated stream is subjected to hydrodynamic cavitation to convert a portion of hydrocarbons in the fractionated stream to lower molecular weight hydrocarbons in a cavitated stream; wherein the fractionated stream is selected from a group consisting of an atmospheric tower bottoms stream, an atmospheric gas oil stream, a vacuum gas oil stream, a quench oil stream, a vacuum tower bottoms stream, and combinations thereof.

Paragraph B—The method of Paragraph A, wherein the fractionated stream comprises a. 1050+° F. boiling point fraction, and wherein the hydrodynamic cavitation unit converts at least 1 to 35 wt % of the 1050+° F. boiling point fraction to lower molecular weight hydrocarbons.

Paragraph C—The method of Paragraph A or B, further comprising feeding at least a portion of the cavitated stream to the distillation unit.

Paragraph D—The method of any of Paragraphs A-C, further comprising recovering at least a portion of the lower molecular weight hydrocarbons by atmospheric fractionation or flash separation.

Paragraph E—The method of any of Paragraphs A-D, wherein the fractionated stream comprises asphaltene molecules, and the hydrodynamic cavitation results in dealkylation of at least a portion of the ashpaltene molecules in the fractionated stream.

Paragraph F—The method of any of Paragraphs A-E, wherein the fractionated stream has a T95 of 600° F. or greater.

Paragraph G—The method of Paragraph F, wherein the fractionated stream has a 195 of 800° F. or greater.

Paragraph H—The method of any of Paragraphs A-G, wherein the hydrodynamic cavitation is performed in the absence of a catalyst.

Paragraph I—The method of any of Paragraphs A-H, wherein the hydrodynamic cavitation is performed in the absence of hydrogen gas or wherein hydrogen gas is present at less than 50 standard cubic feet per barrel.

Paragraph J—The method of any of Paragraphs A-I, wherein the hydrodynamic cavitation is performed in the absence of a diluent oil or water.

Paragraph K—The method of any of Paragraphs A-J, wherein the hydrodynamic cavitation unit subjects the fractionated stream to a pressure drop of at least 400 psig, or more preferably greater than 1000 psig, or more preferably greater than 2000 psig.

Paragraph L—The method of any of Paragraphs A-K, further comprising separating the cavitated stream into a light fraction and a heavy fraction, wherein the heavy fraction has a higher aromaticity in weight percent, as measured by NMR in accordance with ASTM D5292, than the light fraction.

Paragraph M—The method of Paragraph L, wherein the heavy fraction has a higher aromaticity in weight percent than the cavitated stream.

Paragraph N—The method of Paragraph L or M, wherein the heavy fraction has a higher aromaticity in weight percent than the fractionated stream.

Paragraph O—The method of any of Paragraphs A-N, further comprising separating the cavitated stream into a light fraction and a heavy fraction, wherein the heavy fraction has a higher metal content in weight percent than the light fraction. Metals of primary concern to refining processes, such as iron, nickel, and vanadium, can be measured by ASTM D5708.

Paragraph P—The method of Paragraph O, wherein the heavy fraction has a higher metal content in weight percent than the cavitated stream.

Paragraph Q—The method of Paragraph O or P, wherein the heavy fraction has a higher metal content in weight percent than the fractionated stream.

Paragraph R—The method of any of Paragraphs A-Q, further comprising separating the cavitated stream into a light fraction and a heavy fraction, wherein the heavy fraction has a higher Conradson carbon residue (CCR) in weight percent, as measured by ASTM D4530, than the light fraction.

Paragraph S—The method of Paragraph R, wherein the heavy fraction has a higher CCR content in weight percent than the cavitated stream.

Paragraph T—The method of Paragraph R or S, wherein the heavy fraction has a higher CCR in weight percent than the fractionated stream.

Paragraph U—The method of any of Paragraphs A-T, further comprising upgrading the cavitated stream by distillation, extraction, hydroprocessing, hydrocracking, fluidized cat cracking, solvent dewaxing, delayed coking, fluid coking, partial oxidation, gasification, deasphalting, or combinations thereof.

Paragraph V—A system adapted to perform the method of any of Paragraphs A-U.

Paragraph W—A system for improving product from a distillation unit comprising: an atmospheric or vacuum distillation unit; a hydrodynamic cavitation unit receiving a fractionated stream from the distillation unit and subjecting the fractionated stream to hydrodynamic cavitation to convert a portion of hydrocarbons in the fractionated stream to lower molecular weight hydrocarbons in a cavitated stream; wherein the fractionated stream is selected from a group consisting of an atmospheric tower bottoms stream, an atmospheric gas oil stream, a vacuum gas oil stream, a quench oil stream, a vacuum tower bottoms stream, and combinations thereof.

What is claimed is:

1. A method for improving liquid product yield or quality from a distillation unit comprising:
feeding a fractionated stream from an atmospheric or vacuum distillation unit from the distillation unit to a hydrodynamic cavitation unit wherein the fractionated stream is subjected to hydrodynamic cavitation to convert a portion of hydrocarbons in the fractionated stream to lower molecular weight hydrocarbons in a cavitated stream; wherein the fractionated stream is selected from a group consisting of an atmospheric tower bottoms stream, an atmospheric gas oil stream, a vacuum gas oil stream, a quench oil stream, a vacuum tower bottoms stream, and combinations thereof.

2. The method of claim 1, wherein the fractionated stream comprises a 1050+° F. boiling point fraction, and wherein the hydrodynamic cavitation unit converts at least 1 to 35 wt % of the 1050+° F. boiling point fraction to lower molecular weight hydrocarbons.

3. The method of claim 1, further comprising feeding at least a portion of the cavitated stream to a distillation unit.

4. The method of claim 1, further comprising recovering at least a portion of the lower molecular weight hydrocarbons by atmospheric fractionation or flash separation.

5. The method of claim 1, wherein the fractionated stream has a T95 of 600° F. or greater.

6. The method of claim 5, wherein the fractionated stream has a T95 of 800° F. or greater.

7. The method of claim 1, wherein the hydrodynamic cavitation is performed in the absence of a catalyst.

8. The method of claim 1, wherein the hydrodynamic cavitation is performed in the absence of a hydrogen containing gas or wherein hydrogen gas is present at less than 50 standard cubic feet per barrel.

9. The method of claim 1, wherein the hydrodynamic cavitation is performed in the absence of a diluent oil or water.

10. The method of claim 1, wherein the hydrodynamic cavitation unit subjects the fractionated stream to a pressure drop of at least 400 psig.

11. The method of claim 10, wherein the pressure drop is greater than 1000 psig.

12. The method of claim 11, wherein the pressure drop is greater than 2000 psig.

13. The method of claim 1. further comprising separating the cavitated stream into a light fraction and a heavy fraction, wherein the heavy fraction has a higher aromaticity in weight percent, as measured by ASTM D5292, than the light fraction.

14. The method of claim 13, wherein the heavy fraction has a higher aromaticity in weight percent than the cavitated stream.

15. The method of claim 13, wherein the heavy fraction has a higher aromaticity in weight percent than the fractionated stream.

16. The method of claim 1, further comprising separating the cavitated stream into a light fraction and a heavy fraction, wherein the heavy fraction has a higher metal content in weight percent than the light fraction.

17. The method of claim 16, wherein the heavy fraction has a higher metal content in weight percent than the cavitated stream.

18. The method of claim 16, wherein the heavy fraction has a higher metal content in weight percent than the fractionated stream.

19. The method of claim 1, further comprising separating the cavitated stream into a light fraction and a heavy fraction, wherein the heavy fraction has a higher CCR in weight percent, as measured by ASTM D4530 than the light fraction.

20. The method of claim 19, wherein the heavy fraction has a CCR content in weight percent than the cavitated stream.

21. The method of claim 19, wherein the heavy fraction has a higher CCR in weight percent than the fractionated stream.

22. The method of claim 1, further comprising upgrading the cavitated stream by distillation, extraction, hydroprocessing, hydrocracking, fluidized cat cracking, solvent dewaxing, delayed coking, fluid coking, partial oxidation, gasification, deasphalting, or combinations thereof.

23. A system for improving product from a distillation unit comprising:
an atmospheric or vacuum distillation unit;
a hydrodynamic cavitation unit receiving a fractionated stream from the distillation unit and subjecting the fractionated stream to hydrodynamic cavitation to convert a portion of hydrocarbons in the fractionated stream to lower molecular weight hydrocarbons in a cavitated stream; wherein the fractionated stream is selected from a group consisting of an atmospheric tower bottoms stream, an atmospheric gas oil stream, a vacuum gas oil stream, a quench oil stream, a vacuum tower bottoms stream, and combinations thereof.
